(19) United States
(12) Patent Application Publication
(10) Pub. No.: US 2007/0199232 A1
(43) Pub. Date: Aug. 30, 2007

(54) Weedless topwater fishing lure

(76) Inventor: Robert L. Littlejohn, Fruitvale, TX (US)

Correspondence Address: LAW OFFICE OF STEVEN B. LEAVITT, L.L.P., P.O. BOX 537, ROWLETT, TX, 75030-0537, US

(21) Appl. No.: 11/362,986

(22) Filed: Feb. 27, 2006

(51) Int. Cl. A01K 85/02; A01K 85/00

(52) U.S. Cl. 43/42.1; 43/42.24; 43/42.37; 43/42.41

(57) ABSTRACT

A weedless topwater lure that simulates the movement and action of fleeing prey and is attractive to fish. In addition, the lure is rigged in a manner that allows a major portion of the fishing hook to be hidden inside the lure body to avoid entanglement in vegetation in the water or on its surface. The lure comprises a single, integral unit made of a soft, pliable, plastic material with a main body portion terminating in a bell-shaped head and a slender, curled tail end having a flat, rounded tip. A hook channel running at least a portion of the underside of the main body is used to rig the lure with a fishing hook in a manner that hides the majority of the hook inside the lure body. When the lure is drawn across water, the head appears to “gulp” in and expel water to simulate the action of live prey.

### BACKGROUND OF THE INVENTION

1. Technical Field

This invention relates generally to fishing lures and, more particularly, to a weedless topwater fishing lure that simulates the movement of fleeing prey and when used, makes a sound that is attractive to fish.

2. Description of Related Art

Many efforts have been made to simulate the shape, movement, sound and smell of different types of food that fish are attracted to and it is well known that fish are attracted to artificial lures that simulate these characteristics of their natural prey. With the advent of soft plastic materials, lures have been created to resemble worms, crawfish, frogs, and the like. Not only can soft plastic lures be shaped and colored to resemble natural prey, they also have the ability to bend and twist allowing them to simulate live bait movement. These soft plastic lures are relatively inexpensive to manufacture and readily available for individuals who fish to purchase or produce themselves using lure molds.

Despite the obvious advantages of soft plastic lures, there are drawbacks to their use. Although these lures have the ability to somewhat mimic the motion of live prey, the motion exhibited is usually unnatural and unattractive to fish. Also, because many of these lures are typically rigged in a manner in which the fishing hook is disposed outside the body of the lure, the lure can easily get entangled in any vegetation it encounters in or on the surface of the water. In addition, a visible fishing hook is another unnatural quality of a fishing lure that can be unattractive to fish. An additional drawback to soft plastic lures is, due to their soft, pliable nature, a fish may be able to bite through the lure and avoid a trailing or exposed fishing hook resulting in escape from capture.

Therefore, there exists a continuing need for a new and improved one piece, soft plastic topwater fishing lure that simulates the attractive shape and movements of desired fish's natural prey. Further, the need exists for the improved lure to be rigged with a fishing hook in a manner that makes the lure “weedless” or less prone to entanglement in vegetation in the water or on its surface without compromising the integrity of the lure body. It is also desirable that an improved lure when used during fishing make sounds that are attractive to fish.

### SUMMARY OF THE INVENTION

The present invention addresses the foregoing need for an improved lure and is a weedless topwater lure that is comprised of a single, integral unit made of a soft, pliable, plastic material with a main body portion terminating in a bell-shaped head and a slender, curled tail end having a flat, rounded tip. The bell-shaped head end has a deeply cupped interior completely exposed to the air, water, and vegetation of the fishing environment. A hook channel runs the length of the underside of the main body portion of the lure. The hook channel can be used to rig the lure with a hook in a manner that hides the hook inside the main body portion of the lure and prevents the hook from becoming entangled in vegetation.

The primary advantages of the lure is its ability to simulate the movement and action of fleeing prey moving along the surface of the water, the creation of an intake of water to create an apparent “gulping” in and expelling of water that creates a “popping” sound. Also, the lure of the present invention includes a hidden fish hook inside the body of the lure making the lure more attractive to fish and less prone to entanglement in vegetation in or on the surface of the water.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is side view of a weedless topwater fishing lure in accordance with the present invention;

FIG. 2 is a top view of a weedless topwater fishing lure in accordance with the present invention;

FIG. 3 is a cross-sectional view of a weedless topwater fishing lure in accordance with the present invention; and

FIG. 4 is a bottom view of a weedless topwater fishing lure in accordance with the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

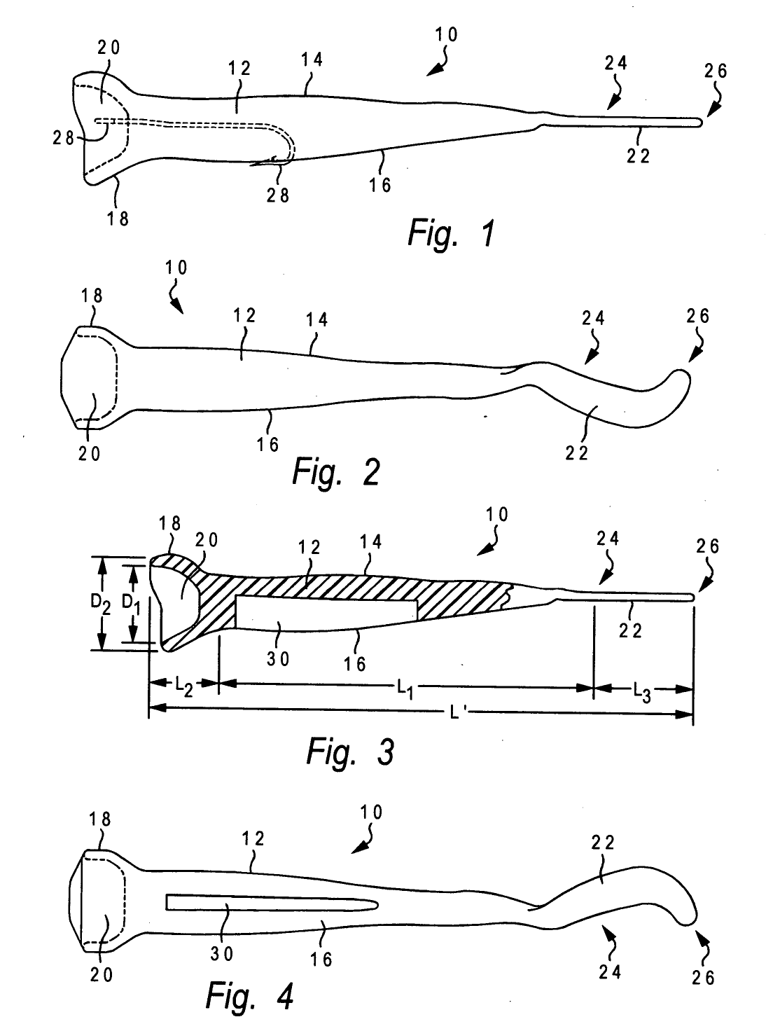

With reference to the accompanying drawings, a preferred embodiment of weedless topwater fishing lure 10 is shown in FIG. 1. Lure 10 is comprised of a single, integral unit containing head end 18, tail end 22, and main body portion 12.

Main body portion 12 is substantially cylindrical in shape and terminates at head end 18 and tail end 22. In addition, the circumference of main body portion 12 is widest at its center and tapers down to tail end 22. Main body portion 12 contains topside 14 and underside 16. During use, underside 16 is typically in contact with the surface of the water. Underside 16 contains at least a portion of hook channel 30 as shown in FIGS. 3 and 4.

Hook channel 30 is a linear channel and runs at least a portion of the length of underside 16 of main body portion 12. Hook channel 30 has a width between about 1/48 of an inch and about ¼ of an inch and a length between about 1/32 of an inch and about ⅜ of an inch. Preferably, as shown in FIG. 1, the depth and width of hook channel 30 is such that a fishing hook similar to hook 28 can be relatively easily attached to lure 10 and at least a portion of the hook is contained within channel 30 without compromising the structural integrity of lure 10. In the preferred embodiment of lure 10, which has an overall length L′ of about 6 inches, the width and depth of hook channel 30 is about ⅛ of an inch and about 3/16 of an inch, respectively.

Head end 18 has a deeply cupped, bell-like shape. Cupped interior 20 of head end 18 is completely exposed to the water, air, vegetation and any other material in the fishing environment. In use, cupped interior 20 appears to “gulp” in and expel water when lure 10 breaks or moves along the water surface which is similar to the action exhibited by live prey. In addition, the intake and expulsion of water as lure 10 breaks or moves along the water surface produces a popping sound that is attractive to fish.

Tail end 22 comprises slender, curled portion 24 and distal end 26. Curled portion 24 spirals upward and inward toward topside 14 of main body portion 12 and terminates at distal end 26. Distal end 26 is relatively flat and rounded at the edges. The circumference of curled portion 24 is consistent up to and until distal end 26.

Preferably, lure 10 is made of a soft, pliable, resilient plastic material that may be colored if so desired. The size of lure 10 can be of any effective length sufficient to attract desired fish. Typically, the effective length will vary from about 1 inch to about 12 inches in overall length. In one embodiment, to ensure that the motion or “action” that lure 10 exhibits when used, the following physical ratios, shown in FIG. 3, should be roughly followed: (a) about 6:1:4 (length L1 of main body portion 12 to length L2 of head end 18 to length L3 of tail end 22, extended); (b) about 1.75:1 (length L3 of tail end 22, extended, to length of distal end 26 from base to tip); (c) about 2.8:1:1.2 (diameter D1 of main body portion 12 to diameter D2 of cupped interior 20 of head end 18 to outermost diameter of curled portion 24 of tail end 22); and (d) about 1:1.2 (diameter D2 of cupped interior 20 of head end 18 to depth of cupped interior 20).

In use, a fishing hook 28 is inserted into lure 10 using hook channel 30 such that a majority of hook 28 is hidden inside main body portion 12. The use of hook channel 30 greatly reduces the exposure of hook 28 to the fishing environment, essentially making lure 10 a “weedless” lure and less prone to entanglement in vegetation in the water or on its surface. In addition, because a majority of hook 28 is hidden inside main body portion 12, lure 10 is more attractive to fish due to the reduction of the unnatural aspect of an exposed hook.

When pulled through the water, lure 10 moves similar to fleeing prey making it particularly attractive to fish such as bass, striper, and wahoo. The action produced by lure 10 is particularly effected by the bell-shaped head end 18 as it moves through the water and creates eddies. These eddies buffet the sides of main body portion 12 and tail end 22 of lure 10 causing them to bend and twist. In addition to this action, head end 18 appears to “gulp” in and expel water when lure 10 breaks or moves along the water surface and such action is similar to the action exhibited by live prey. Also, the deeply cupped interior 20 of head end 18 appears to take in water and, when the action of main body portion 12 and tail end causes head end 18 to move quickly upwards, cupped interior 20 will appear to expel the water into the air and produce a “popping” sound that is often attractive to fish.

The invention has been described with reference to a preferred embodiment. Obviously, modification and alterations will occur to others skilled in the art upon reading and understanding of this specification. All modifications and alterations are included insofar as they come within the scope of the appended claims and equivalents thereof.

What is claimed is:

1. A weedless topwater fishing lure, the lure comprising:
a main body portion substantially cylindrical in shape having a body diameter, terminating in a head end and a tail end wherein the main body portion has a hook channel, and the head end has a cupped interior with an interior depth, interior diameter.

2. The lure of claim 1 wherein the tail end has a curled portion and a relatively flat distal end.

3. The lure of claim 1 wherein said main body portion comprises a topside and an underside wherein the underside contains at least a portion of the hook channel.

4. The lure in claim 3 wherein the hook channel is substantially linear.

5. The lure in claim 2 wherein the hook channel has a width between about 1/48 of an inch and about ¼ of an inch and a length between about 1/32 of an inch and about ⅜ of an inch.

6. The lure in claim 2 wherein the hook channel has a width of about ⅛ of an inch and length of about 3/16.

7. The lure in claim 1 wherein the ratio between the main body diameter to the interior diameter is about 2.8:1.

8. The lure in claim 1 wherein the ratio between the main body portion and the head end is about 6:1.

9. The lure in claim 1 wherein the ratio between the head end and the tail end is 1:4.

10. The lure in claim 1 wherein the ratio between interior diameter and interior depth is about 1:1.2.

11. The lure in claim 10 wherein the ratio between the main body diameter to the interior diameter is about 2.8:1.

12. The lure in claim 11 wherein the ratio between the main body portion and the head end is about 6:1.

13. The lure in claim 12 wherein the ratio between the head end and the tail end is 1:4.

14. A method of fishing with a weedles topwater fishing lure, the method comprising the steps of:
casting a fishing lure wherein the lure comprises a main body portion substantially cylindrical in shape having a body diameter, terminating in a head end and a tail end wherein the main body portion has a hook channel, the head end has a cupped interior with an interior depth, interior diameter and the tail end has a curled portion and a relatively flat distal end; and
reeling in the casted lure whereby the head end gulps in and expels water simulating live prey.

15. The method in claim 14 wherein the hook channel has a width between about 1/48 of an inch and about ¼ of an inch and a length between about 1/32 of an inch and about ⅜ of an inch.

16. The method in claim 2 wherein the hook channel has a width of about ⅛ of an inch and length of about 3/16.

17. The method in claim 1 wherein the ratio between the main body diameter to the interior diameter is about 2.8:1.

18. The method in claim 1 wherein the ratio between the main body portion and the head end is about 6:1.

19. The method in claim 1 wherein the ratio between the head end and the tail end is about 1:4.

20. The method in claim 1 wherein the ratio between interior diameter and interior depth is about 1:1.2.
